(19) United States
(12) Patent Application Publication
(10) Pub. No.: US 2018/0164114 A1
(43) Pub. Date: Jun. 14, 2018

(54) Vehicle Navigation Display System And Method Thereof

(71) Applicants: Inventec (Pudong) Technology Corporation, Shanghai (CN); Inventec Corporation, Taipei City (TW)

(72) Inventor: Chaucer Chiu, Taipei (TW)

(21) Appl. No.: 15/622,721

(22) Filed: Jun. 14, 2017

(30) Foreign Application Priority Data
Dec. 14, 2016 (CN) 201611151127.9

(51) Int. Cl. G01C 21/36; G06F 3/0481; G06F 3/0484; G06F 3/0488; G06T 19/00; G06T 7/13

(52) U.S. Cl. CPC G01C 21/365; G06F 3/04817; G06F 3/04845; G06F 3/04883; G06T 2210/62; G06T 7/13; G01C 21/3697; G06T 2207/30256; G06T 19/006

(57) ABSTRACT

A vehicle navigation display system is disclosed. A processing module of a transparent display device receives and analyzes a current image in front of a driver's seat of a vehicle, to obtain a contour of a street in the current image, and then generates an indication icon according to the contour of the street and a navigation signal generated by a navigation device. A transparent display module is served as a vehicle windshield to display the indication icon, and the indicator icon is superimposed on the street position in the current image, and the transparency of the transparent display module can be adjusted according to the light intensity of the environment. As a result, the vehicle navigation display system enables the different drivers to clearly see the indication icon with the navigation function in any lighting environment, and also see the indication icon with a sense of augmented reality.

### CROSS-REFERENCE TO RELATED APPLICATION

This application claims the benefit of Chinese Patent Application No. 201611151127.9, filed Dec. 14, 2016.

### BACKGROUND

### Field of the Invention

The present disclosure relates to a navigation system and method thereof, more particularly to a vehicle navigation display system and method thereof.

### Description of the Related Art

In recent years, navigation systems are widely used to assist drivers in moving to destinations. The existing navigation system is able to generate multiple navigation paths according to a particular starting position and a destination position, and then calculate travel time of each navigation path according to a path length and road grades of each navigation path, and a display and a loudspeaker of the navigation system respectively show and broadcast a navigation message to instruct the driver with a route to the destination.

Furthermore, the navigation system may be installed with a head-up display (HUD) system configured to display navigation message to facilitate the driver to use the navigation system. The head-up display system projects a virtual image on a particular area of the windshield at the driver's eye level, so that the driver may directly view the navigation message without removing line-of-sight. As a result, the head-up display system may improve driving safety for the driver.

However, the conventional head-up display system displays an image on a limited area of the windshield, so different driver must adjust a projection position of the head-up display device in advance to clearly view the projected navigation image.

Therefore, the conventional technology has the problem that the different driver must adjust the projection position of the head-up display device in advance to clearly view the projected navigation image. For this reason, what is need is to improve the navigation display system to solve the problem.

### SUMMARY

In order to solve the conventional technology problem, the present disclosure provides a vehicle navigation display system and method thereof.

The present disclosure provides a vehicle navigation display system including a navigation device, an image capture device, and a transparent display device. The navigation device is configured to receive a starting position and a destination position, and includes a storage module and a navigation module. The storage module is configured to store a digital map. The navigation module is electrically coupled to the storage module and configured to calculate a navigation route according to the starting position, the destination position and the digital map, and continuously detect a current position of a vehicle, and then generate a navigation signal for the current position. The image capture device is configured to capture a current image in front of a driver's seat of the vehicle. The transparent display device is electrically coupled to the navigation device and the image capture device, and includes a processing module, a transparent display module and a sensing module. The processing module is configured to receive and analyze the current image to obtain a contour of a street in the current image, and determine an indication icon according to the contour of the street and the navigation signal. The transparent display module is electrically coupled to the processing module and configured to display the indication icon which is superimposed on a position of the street in the current image. The transparent display module is served as a windshield of the vehicle. The sensing module is electrically coupled to the processing module and configured to sense light intensity of environment in front of the vehicle. The processing module adjusts transparency of the transparent display module according to the light intensity of the environment.

Furthermore, the present disclosure provides a vehicle navigation display method including steps: receiving a starting position and a destination position; storing a digital map; calculating a navigation route according to the starting position, the destination position and the digital map, and continuously detecting a current position of a vehicle, and then generating a navigation signal for the current position; obtaining a current image in front of a driver's seat of the vehicle; receiving and analyzing the current image to obtain a contour of a street in the current image; determining an indication icon according to the contour of the street and the navigation signal; displaying, by a transparent display module served as a windshield of the vehicle, the indication icon which is superimposed on a position of the street in the current image; sensing light intensity of environment in front of the vehicle; and adjusting transparency of the transparent display module according to the light intensity of the environment.

By aforementioned technical means, different drivers may clearly see the indication icon with navigation function in any lighting environment, and also see the indication icon with a sense of augmented reality.

### BRIEF DESCRIPTION OF THE DRAWINGS

The structure, operating principle and effects of the present disclosure will be described in detail by way of various embodiments which are illustrated in the accompanying drawings.

FIG. 1 is a system block diagram of an embodiment of a vehicle navigation display system.

FIG. 2 is a schematic view of an embodiment of a current image in front of a driver's seat of a vehicle.

FIG. 3 is a schematic view of an embodiment of a scene seen by the driver sitting at the driver's seat.

FIG. 4 is a flowchart showing the steps in an operation of a vehicle navigation display method for the vehicle navigation display system shown in FIG. 1.

FIG. 5 is a system block diagram of other embodiment of the vehicle navigation display system.

FIG. 6 is an enlarged view of the indication icon of FIG. 3.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

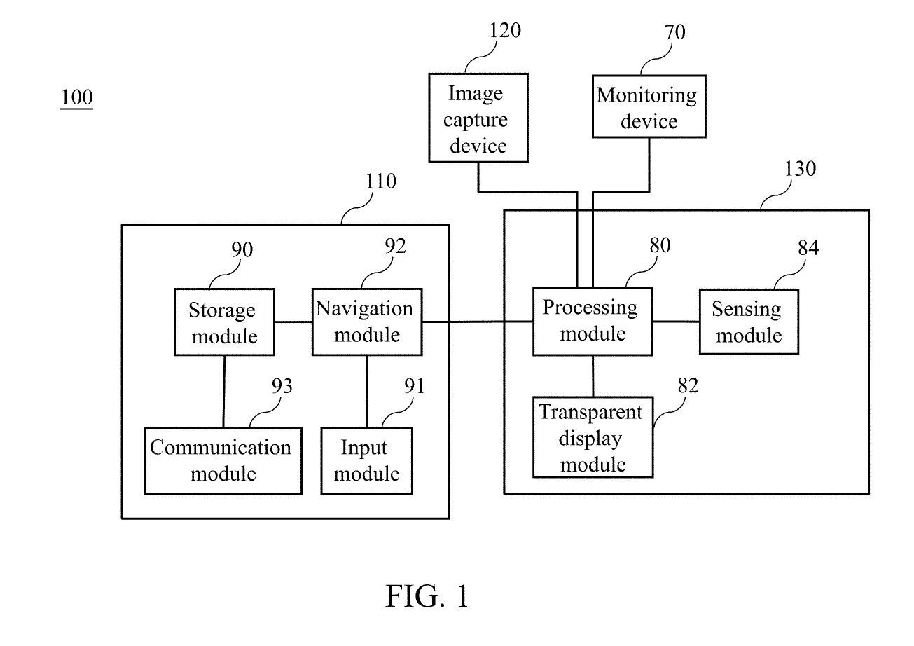

Please refer to FIG. 1, which is a system block diagram of an embodiment of a vehicle navigation display system of the present disclosure. The vehicle navigation display system 100 includes a navigation device 110, an image capture device 120 and a transparent display device 130. The navigation device 110 is configured to receive a starting position and a destination position, and includes a storage module 90 and a navigation module 92. The storage module 90 is configured to store a digital map, and the navigation module 92 is electrically coupled to the storage module 90 and configured to calculate a navigation route according to the starting position, the destination position and the digital map, and continuously detect a current position of a vehicle, and then generate a current navigation signal for the current position. In this embodiment, the navigation signal may be an instruction indicating the driver to move straight ahead. Preferably, the storage module 90 may be a hard disk or memory device.

In this embodiment, the navigation device 110 further includes an input module 91 configured to provide an input interface for the driver to input the starting position and the destination position. Preferably, the input module 91 may be a keyboard or microphone; when the keyboard is used as the input module 91, the driver may input the starting position and the destination position by finger; when the microphone is used as the input module 91, the driver may input the starting position and the destination position by speech. Preferably, each of the starting position and the destination position may be an address, a special landmark, a school or a government office. The navigation device 110 may include a communication module 93 electrically coupled to the storage module 90. The digital map stored in the storage module 90 is updated through the communication module 93 periodically or irregularly, and the updating time for the digital map may be adjusted upon practical demand.

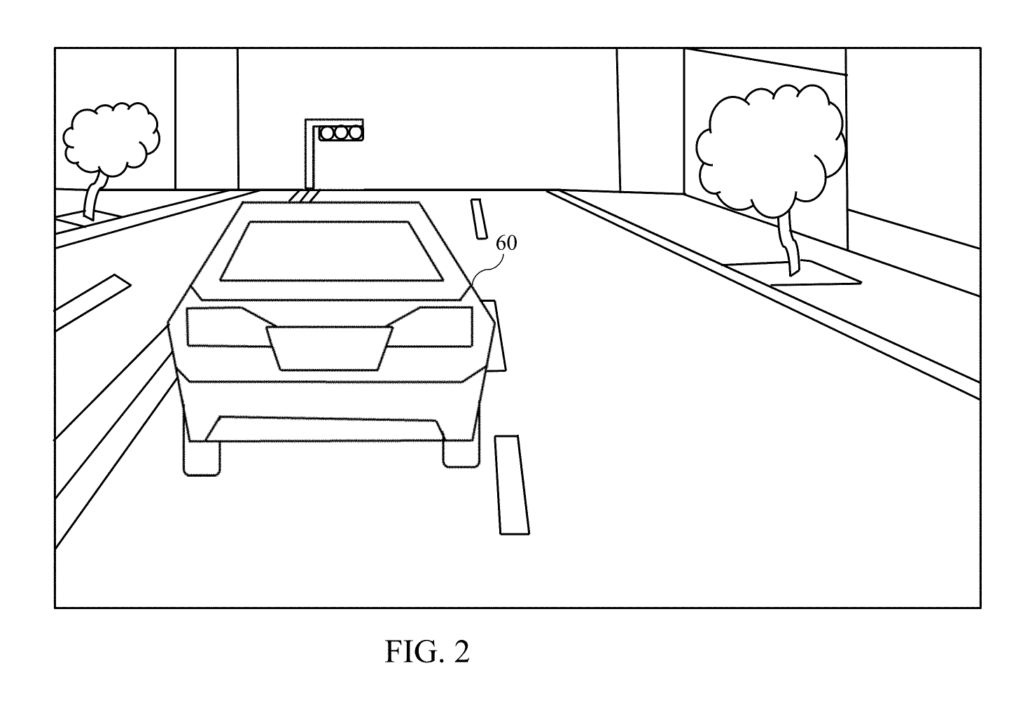

The image capture device 120 is configured to obtain a current image in front of the driver's seat of the vehicle, as shown in FIG. 2 which is a schematic view of an embodiment of the current image in front of the driver's seat of the vehicle. The current image captured by the image capture device 120 may be almost the same as the scene seen by the driver through a windshield while the driver sits at the driver's seat, that is, a viewing angle of the image capture device 120 is close to the driver's viewing angle. Preferably, the image capture device 120 may be a digital still camera, a digital camcorder or a driving recorder, and the image capture device 120 may be mounted inside or outside the vehicle, and output the current image to the transparent display device 130 by a wired or wireless transmission manner. Alternatively, the image capture device 120 may be a wearable device worn on the driver and output the current image to the transparent display device 130 by the wireless transmission manner.

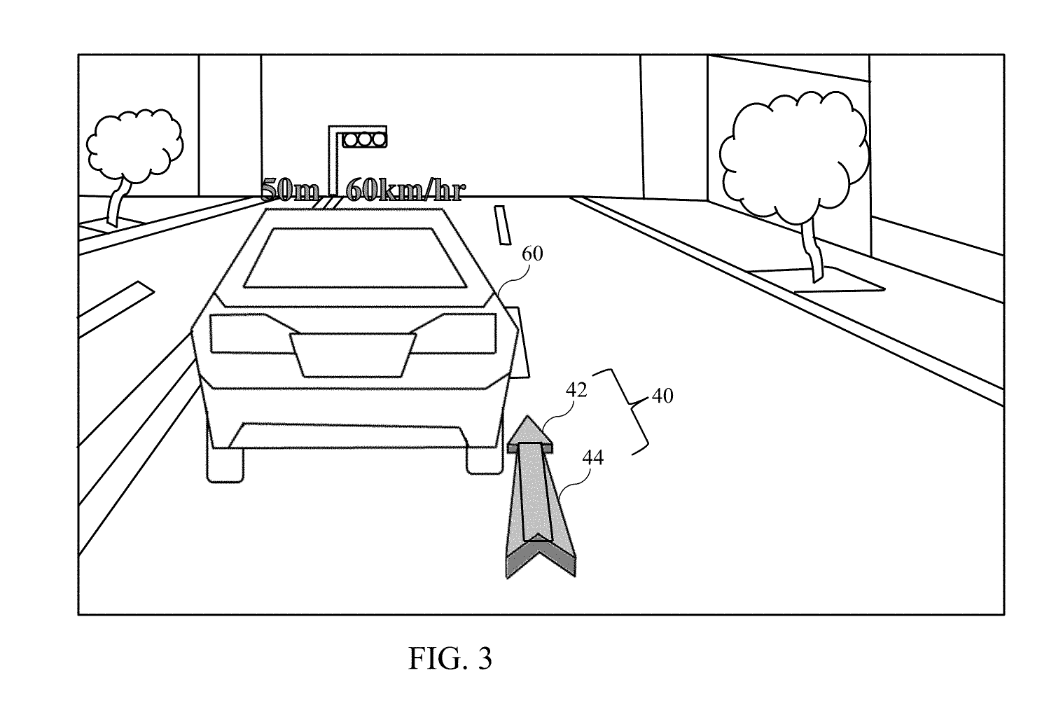

Please refer to FIGS. 1 and 3. FIG. 3 is a schematic view of an embodiment of the scene viewable to the driver sitting at the driver's seat. The transparent display device 130 is electrically coupled to the navigation device 110 and the image capture device 120, and includes a processing module 80, a transparent display module 82 and a sensing module 84. The processing module 80 is electrically coupled to the navigation device 110, the image capture device 120, the transparent display module 82 and the sensing module 84. The processing module 80 is configured to receive and analyze the current image to obtain a contour of a street contained in the current image, and then determine an indication icon 40 according to the contour of the street and the navigation signal. It should be noted that when the current image captured by the image capture device 120 is different from the scene viewed by the driver through the windshield while the driver sits at the driver's seat (that is, the viewing angle of the image capture device 120 is different from the driver's viewing angle), the processing module 80 adjusts the current image prior to the analysis for the current image to make the adjusted current image the same as the scene viewed by the driver through the windshield while the driver sits at the driver's seat, and then determines a display position of the indication icon 40 on the transparent display module 82.

The indication icon 40 includes an arrow head 42 and an arrow body 44, and the processing module 80 determines a contour of the arrow body 44 according to the contour of the street in the current image, and determines a direction of the arrow head 42 according to the navigation signal, so that the indication icon 40 may be displayed more sense of augmented reality on the current image, that is, the indication icon 40 looks more like an augmented reality image. In this embodiment, the contour of the arrow body may be an inclined straight arrow body extended forwardly, and the direction of the arrow head 42 may be a direction indicative of moving forwardly and straightly; however, the present disclosure is not limited to this embodiment.

The transparent display module 82 is configured to display the indication icon 40, such as the gray icon shown in FIG. 3. The indication icon 40 is superimposed on the street position in the current image, and the transparent display module 82 is served as the windshield of the vehicle. It should be noted that the indication icon 40 does not block the original scene viewable to the driver at the driver's seat, that is, the driver can see a front object through the indication icon 40.

In this embodiment, in order to enhance the display contrast of the transparent display module 82 to satisfy the driver's demand in viewing high-quality indication icon 40, the sensing module 84 can be used to sense light intensity of the environment in front of the vehicle, and then the processing module 80 adjusts transparency of the transparent display module 82 according to the light intensity of the environment, so that the driver may see the indication icon 40 clearly in any lighting environment without blocking the original scene viewable to the driver at the driver's seat. Furthermore, because different types of vehicles may have the windshield with different radians, in this embodiment, the transparent display module served as the windshield of the vehicle may have a different radian, and the processing module 80 adjusts the contour of the indication icon 40 according to the radian, so that the driver may see the indication icon 40 with sense of augmented reality in any type of vehicle.

The vehicle navigation display system 100 may include a monitoring device 70 electrically coupled to the transparent display device 130 and configured to detect and output a current velocity of a front vehicle 60 in the current image and a current distance between the front vehicle 60 and the vehicle, and the transparent display module 82 displays the current velocity and the current distance superimposed above the front vehicle 60 in the current image (such as the gray number shown in FIG. 3) for the driver to read the information about the front vehicle 60, thereby improving driving safety. In this embodiment, the current velocity of the front vehicle 60 is 60 km/hr, and the current distance between the front vehicle 60 and the vehicle is 50 m; however, the present disclosure is not limited to the embodiment.

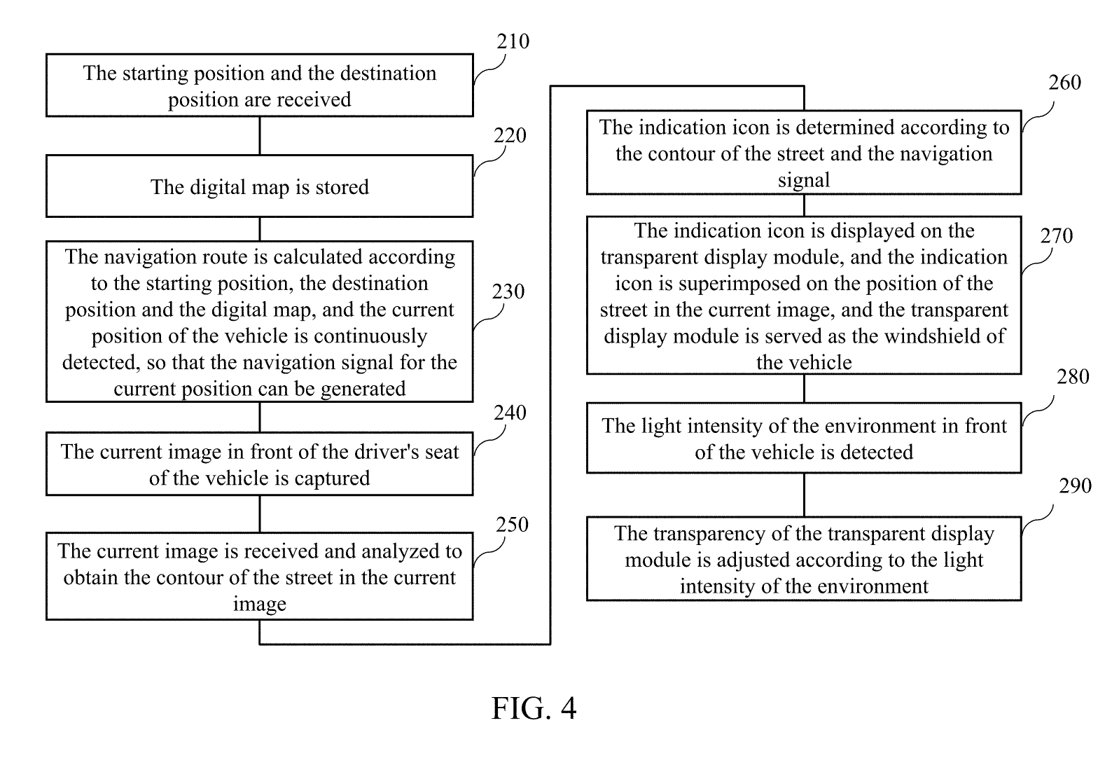

Please refer to FIG. 4 which is a flowchart showing the steps in an operation of a vehicle navigation display method for the navigation display system of FIG. 1. The vehicle navigation display method includes following steps. In a step 210, the starting position and the destination position are received. In a step 220, the digital map is stored. Next, in a step 230, the navigation route is calculated according to the starting position, the destination position and the digital map, and the current position of the vehicle is continuously detected, so that the navigation signal for the current position can be generated. In a step 240, the current image in front of the driver's seat of the vehicle is captured. In a step 250, the current image is received and analyzed to obtain the contour of the street in the current image. In a step 260, the indication icon is determined according to the contour of the street and the navigation signal. Next, in a step 270, the indication icon is displayed on the transparent display module, and the indication icon is superimposed on the position of the street in the current image, and the transparent display module is served as the windshield of the vehicle. In a step 280, the light intensity of the environment in front of the vehicle is detected. In a step 290, the transparency of the transparent display module is adjusted according to the light intensity of the environment. Furthermore, the step of determining the indication icon according to the contour of the street and the navigation signal further includes steps of: determining the contour of the arrow body according to the contour of the street, and determining the direction of the arrow head according to the navigation signal, so that the indication icon displayed on the transparent display module may have the sense of the augmented reality.

By performing aforementioned steps, the indication icon may be superimposed on the position of the street of the current image displayed on the transparent display module which is served as the windshield of the vehicle, and the transparent display module may adjust the transparency thereof according to the light intensity of the environment, so that the driver may clearly see the indication icon with the navigation function in any lighting environment and feel the indicator icon with sense of augmented reality.

Furthermore, the vehicle navigation display method may further include step of updating the digital map, so that the digital map stored in the storage module may be kept as the most update version.

Furthermore, the vehicle navigation display method may also include steps of: detecting and outputting the current velocity of the front vehicle in the current image and the current distance between the front vehicle and the driver's vehicle, and then using the transparent display module to display and superimpose the current velocity and the current distance above the front vehicle in the current image for the driver to read the information about the front vehicle, thereby improving driving safety.

Furthermore, the vehicle navigation display method may further include steps of adjusting the contour of the indication icon according to the radian of the transparent display module, so that the driver may see the indication icon with sense of augmented reality in any type of vehicle having the windshield with different radians.

It is appreciated that aforementioned steps may be performed in any order unless a causal relationship between at least two steps is defined in context.

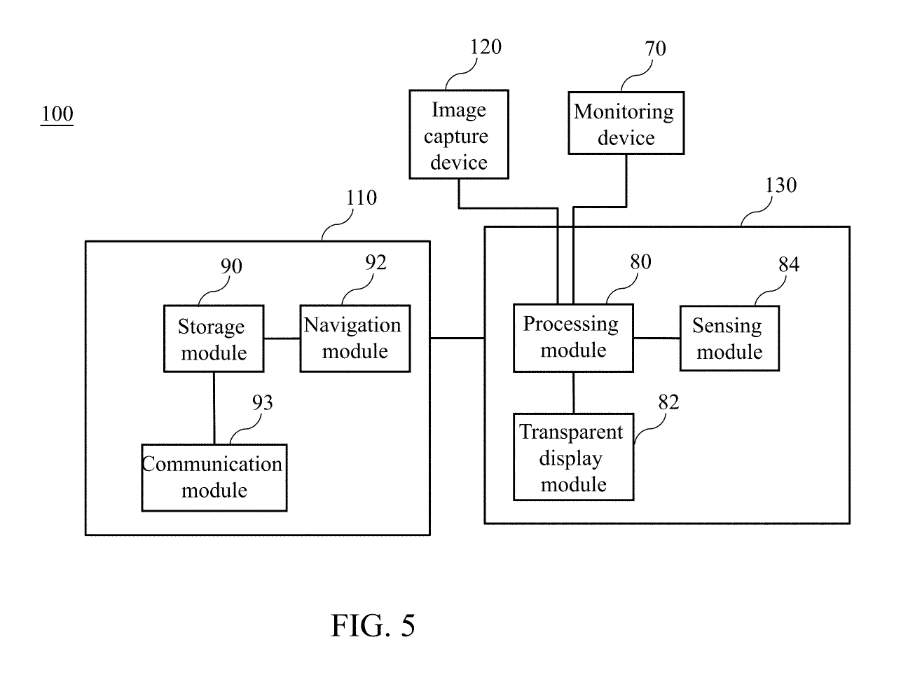

Please refer to FIG. 5 which is a system block diagram of other embodiment of the vehicle navigation display system of the present disclosure. The difference between this embodiment and aforementioned embodiment is that the navigation device 110 of this embodiment does not include the input device 91, and the transparent display device 130 of this embodiment is a touch-controlled display device, so that the driver may input the starting position and the destination position through the transparent display module 82 (that is, the windshield of the vehicle) of the touch-controlled transparent display device 130. In other words, the transparent display module 82 may display an input interface, such as a virtual keyboard, so that the driver may touch the input interface by finger to input the starting position and the destination position. In practice, the transparent display module 82 may be a capacitive touch-controlled display module, which may be a single-point or multi-point touch-controlled device. In this embodiment, the transparent display module 82 is a multi-point capacitive touch-controlled display module, but the present disclosure is not limited thereto.

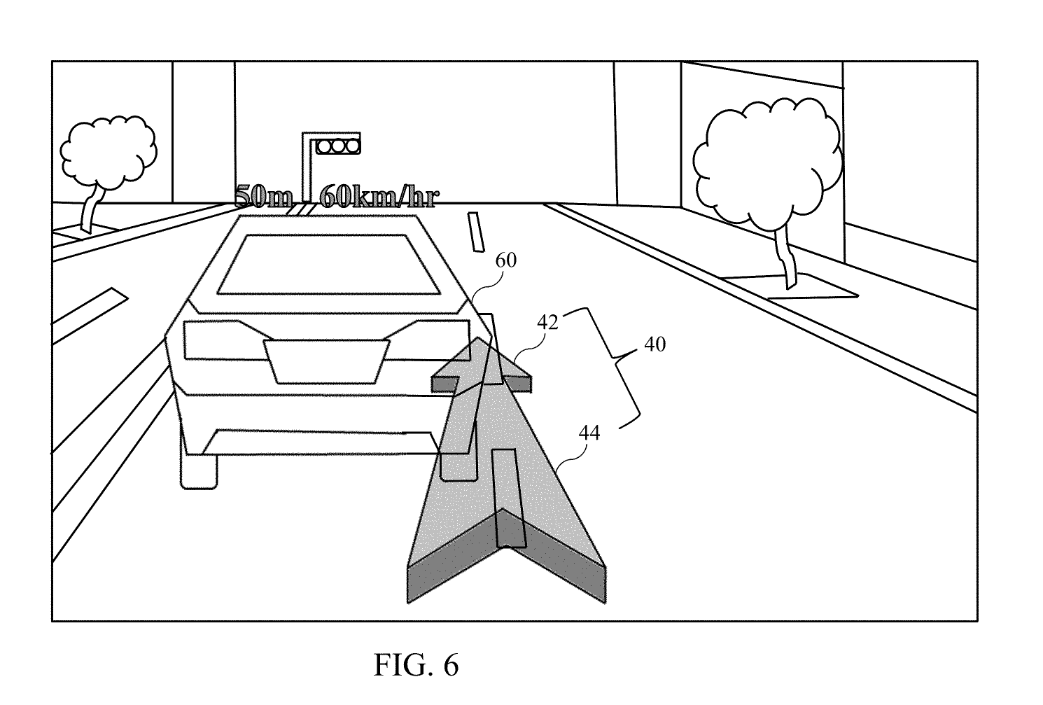

The transparent display device 130 is the touch-controlled display device, so the user can adjust, by a touch gesture, a size of the indication icon 40 shown on the transparent display device 130, upon demand. For example, when the gesture touched on the transparent display module 82 is that two touch points (that is, two fingers touch the transparent display module 82) move apart from each other, a display function corresponding to this gesture is an enlarging function. When the gesture touched on the transparent display module 82 is that two fingers touch points (that is, two finger touches the transparent display module 82) move close to each other, the display function corresponding to this gesture is a shrinking function; however, the present disclosure is not limited to these examples. Furthermore, while the size of the indication icon 40 is being adjusted, the contour of the arrow body 44 is adjusted correspondingly in shape to the contour of the street in the current image. Please refer to FIGS. 5 and 6. FIG. 6 is a schematic view of enlargement of the indication icon of the FIG. 3. When the driver enlarges the indication icon 40 by using the touch gesture upon demand, the processing module 80 receives the enlarging instruction from the transparent display module 82, and then enlarges the contour of the arrow body 44 correspondingly in shape to the contour of the street in the current image, thereby maintaining stereo perception of the enlarged indication icon 40, and enabling the driver to see the indication icon 40 with the sense of the augmented reality.

Besides the step shown in FIG. 4, the vehicle navigation display method further includes steps: adjusting the size of the indication icon according to the gesture; and adjusting the contour of the arrow body correspondingly to the contour of the street in the current image while the size of the indication icon is being adjusted, in order to maintain stereo perception of the indication icon. As a result, the driver may see the indication icon 40 with the sense of the augmented reality. It is appreciated that aforementioned steps may be performed in any order unless a causal relationship between at least two steps is defined in context.

To summarize, the difference between the present disclosure and the conventional technology is that the indication icon of the present disclosure is displayed and superimposed on the street position of the current image on the transparent display module which is served as the windshield of the vehicle, and the transparent display module is able to adjust the transparency thereof according to the light intensity in the environment, thereby solving the problem existing in the conventional technology. As a result, the driver may see the indication icon with sense of augmented reality in any lighting environment.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A vehicle navigation display system mounted in a vehicle, comprising:
a navigation device receiving a starting position and a destination position, and comprising:
a storage module storing a digital map; and
a navigation module electrically coupled to the storage module and configured to calculate a navigation route according to the starting position, the destination position and the digital map, and continuously detect a current position of the vehicle, and then generate a navigation signal for the current position;
an image capture device capturing a current image in front of a driver's seat of the vehicle;
a transparent display device electrically coupled to the navigation device and the image capture device, and comprising:
a processing module receiving and analyzing the current image to obtain a contour of a street in the current image, and determining an indication icon according to the contour of the street and the navigation signal;
a transparent display module electrically coupled to the processing module and configured to display the indication icon which is superimposed on a position of the street in the current image, wherein the transparent display module is served as a windshield of the vehicle;
a sensing module electrically coupled to the processing module and configured to sense light intensity of an environment in front of the vehicle, wherein the processing module adjusts transparency of the transparent display module according to the light intensity of the environment.

2. The vehicle navigation display system according to claim 1, wherein the navigation device further comprises a communication module electrically coupled to the storage module and configured to update the digital map.

3. The vehicle navigation display system according to claim 1, further comprising a monitoring device electrically coupled to the transparent display device and configured to detect and output a current velocity of a front vehicle in the current image and a current distance between the front vehicle and the vehicle, wherein the transparent display module displays and superimposed the current velocity and the current distance on a position above the front vehicle in the current image.

4. The vehicle navigation display system according to claim 1, wherein the indication icon comprises an arrow head and an arrow body, and the processing module determines a contour of the arrow body according to the contour of the street in the current image, and determines a direction of the arrow head according to the navigation signal.

5. The vehicle navigation display system according to claim 4, wherein the transparent display device is a touch-controlled display device configured to adjust a size of the indication icon according to a gesture, and while the size of the indication icon is being adjusted, the processing module adjusts the contour of the arrow body correspondingly to the contour of the street.

6. The vehicle navigation display system according to claim 1, wherein the transparent display module has a radian and the processing module adjusts the contour of the indication icon according to the radian.

7. A vehicle navigation display method, comprising:
receiving a starting position and a destination position;
storing a digital map;
calculating a navigation route according to the starting position, the destination position and the digital map, and continuously detecting a current position of a vehicle, and then generating a navigation signal for the current position;
capturing a current image in front of a driver's seat of the vehicle;
receiving and analyzing the current image to obtain a contour street a street in the current image;
determining an indication icon according to the contour of the street and the navigation signal;
displaying the indication icon by a transparent display module, wherein the indication icon is superimposed on a position of the street in the current image, and the transparent display module is served as a windshield of the vehicle;
sensing light intensity of an environment in front of the vehicle; and
adjusting transparency of the transparent display module according to the light intensity of the environment.

8. The vehicle navigation display method according to claim 7, further comprising: updating the digital map.

9. The vehicle navigation display method according to claim 7, further comprising:
detecting and outputting a current velocity of a front vehicle in the current image and a current distance between the front vehicle and the vehicle; and
displaying the current velocity and the current distance by the transparent display module, wherein the current velocity and the current distance are superimposed on a position above the front vehicle in the current image.

10. The vehicle navigation display method according to claim 7, wherein the indication icon includes an arrow head and an arrow body, and the step of determining the indication icon according to the contour of the street and the navigation signal further comprises:
determining a contour of the arrow body according to the contour of the street; and
determining a direction of the arrow head according to the navigation signal.

11. The vehicle navigation display method according to claim 10, further comprising:
adjusting a size of the indication icon according to a gesture; and
adjusting the contour of the arrow body correspondingly to the contour of the street in the current image, while the size of the indication icon is being adjusted.

12. The vehicle navigation display method according to claim 7, further comprising: adjusting the contour of the indication icon according to a radian of the transparent display module.
